(19) United States
(12) Patent Application Publication
(10) Pub. No.: US 2026/0056873 A1
(43) Pub. Date: Feb. 26, 2026

(54) AUTONOMOUS LEARNING OF CONTEXT-SPECIFIC ALLOWLISTS WITH CONFIDENCES

(71) Applicant: Oracle International Corporation, Redwood Shores, CA (US)

(72) Inventors: Robert FRANCIS, Brisbane (AU); Francois GAUTHIER, Brisbane (AU); Myles ROSSINI, Brisbane (AU)

(73) Assignee: Oracle International Corporation, Redwood Shores, CA (US)

(21) Appl. No.: 18/814,453

(22) Filed: Aug. 23, 2024

(51) Int. Cl. G06F 11/36

(52) U.S. Cl. CPC G06F 11/3688; G06F 11/3692; G06F 11/3698

(57) ABSTRACT

Autonomous learning of context-specific allowlists with confidences includes performing operations. The operations include obtaining a first batch of observations of an operation in a context and partitioning the first batch of observations by the context to obtain subsets of observations. The operations further include, for each subset of a plurality of subsets of observations to obtain metrics and confidence ratings, selecting, according to the context, a context-specific allowlist from multiple context-specific allowlists, comparing the operation in each observation in the subset to the context-specific allowlist to obtain a metric regarding the subset, calculating a confidence rating for the metric from the subset, and updating the context-specific allowlist for the first batch of observations. The operations further include deploying the plurality of context-specific allowlists when the metrics and the confidences satisfy a threshold.

### BACKGROUND

Software vulnerabilities are being found and exploited on a regular basis. To reduce the attack surface that an application exposes, security measures can be put in place at various stages of the development cycle. From secure coding practices to static and dynamic security testing, crawling and fuzzing, and web application firewalls, a plethora of tools exists to help developers and operators protect their applications from attackers. One type of technology is runtime application self-protection (RASP), which is a technology that monitors application behavior, controls application execution, and detects and prevents real-time attacks.

RASP technologies are deployed in production, alongside the application. Hence, RASP tools are expected to have negligible runtime overhead, not to interfere with any legitimate execution of the application, and to block attacks. In practice, achieving this goal is a challenge. Further, blocklisting solutions that prevent the execution of commands including untrusted inputs may be evaded. Allowlisting that only allows predefined commands and inputs may be more robust against attacks and can have usability issues. Differences exist between allowlists and blocklists. While blocklists can be shared across applications, allowlists are application specific. Further, while blocklists strictly expand over time (e.g., malicious payloads never become benign), allowlists need to evolve with the code that the allowlist protects.

### SUMMARY

In general, in one aspect, one or more embodiments relate to a method. The method includes obtaining a first batch of observations of an operation in a context and partitioning the first batch of observations by the context to obtain subsets of observations. The method further includes, for each subset of a plurality of subsets of observations to obtain metrics and confidence ratings, selecting, according to the context, a context-specific allowlist from multiple context-specific allowlists, comparing the operation in each observation in the subset to the context-specific allowlist to obtain a metric regarding the subset, calculating a confidence rating for the metric from the subset, and updating the context-specific allowlist for the first batch of observations. The method further includes deploying the plurality of context-specific allowlists when the metrics and the confidences satisfy a threshold.

In general, in one aspect, one or more embodiments relate to a system that includes a data repository including context-specific allowlists and a computer processor including computer readable program code for causing a computer system to perform operations. The operations include obtaining a first batch of observations of an operation in a context and partitioning the first batch of observations by the context to obtain subsets of observations. The operations further include, for each subset of a plurality of subsets of observations to obtain metrics and confidence ratings, selecting, according to the context, a context-specific allowlist from multiple context-specific allowlists, comparing the operation in each observation in the subset to the context-specific allowlist to obtain a metric regarding the subset, calculating a confidence rating for the metric from the subset, and updating the context-specific allowlist for the first batch of observations. The operations further include deploying the plurality of context-specific allowlists when the metrics and the confidences satisfy a threshold.

In general, in one aspect, one or more embodiments relate to a non-transitory computer readable medium having computer readable program code for causing a computer system to perform operations. The operations include obtaining a first batch of observations of an operation in a context and partitioning the first batch of observations by the context to obtain subsets of observations. The operations further include, for each subset of a plurality of subsets of observations to obtain metrics and confidence ratings, selecting, according to the context, a context-specific allowlist from multiple context-specific allowlists, comparing the operation in each observation in the subset to the context-specific allowlist to obtain a metric regarding the subset, calculating a confidence rating for the metric from the subset, and updating the context-specific allowlist for the first batch of observations. The operations further include deploying the plurality of context-specific allowlists when the metrics and the confidences satisfy a threshold.

Other aspects of the invention will be apparent from the following description and the appended claims.

### BRIEF DESCRIPTION OF DRAWINGS

FIG. 1 shows an example of a system in accordance with one or more embodiments.

FIG. 2 shows a flowchart in accordance with one or more embodiments.

FIG. 3A and FIG. 3B show a computing system in accordance with one or more embodiments of the invention.

Like elements in the various figures are denoted by like reference numerals for consistency.

### DETAILED DESCRIPTION

In general, embodiments are directed to learning context-specific allowlists with confidence. An allowlist is a list that defines which operations are permissible. Context-specific allowlists are a set of allowlists in which each allowlist in the set is dependent on context. A single allowlist for an entire application has the downside that the single allowlist may be overly permissive if the single allowlist does not distinguish between area contexts of the program. For example, the application may contain an authenticator service which accesses sensitive information from a database. If a single allowlist was used for the entire application then, if an attacker found a way to perform the same sensitive operation from a user facing service, the allowlist would let the sensitive operation to be performed. Context-specific allowlisting provides for a finer granularity in a security policy by having each context of the application to have a corresponding allowlist. One or more embodiments learn context-specific allowlists over multiple operations spanning multiple contexts.

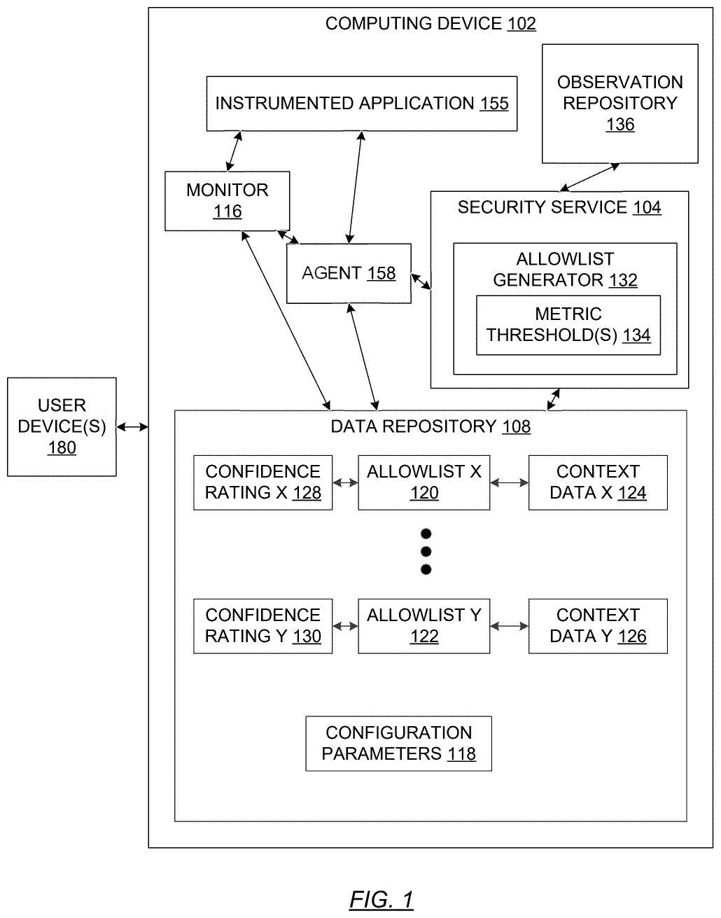

Turning to FIG. 1, FIG. 1 shows a diagram of a system in accordance with one or more embodiments. As shown in FIG. 1, the system includes one or more user devices (180). The user device(s) may be configured to interface with the computing device (102). The computing device (102) and the user device(s) (180) may each be computing systems in accordance with FIG. 7A and FIG. 7B. For example, the computing device and user device may each include multiple physical devices or may be virtual device(s) that operate on one or more physical devices. The user devices (180) may execute or interface with at least a portion of at least one instrumented application (155). For example, the user device may execute another user application through which the user operations services of the instrumented application (155). The user application may include user interfaces with user interface elements to receive inputs and display outputs to the users of the computing device (102). As another example, the instrumented application (155) may be a web application.

The application (155) is a program that obtains inputs and generates outputs in response to the inputs. The inputs may be from a user or another program. During training phase when the context-specific allowlists are generated, the computing device and user device is a trusted environment in one or more embodiments. In such a scenario, each operation triggered by the user devices is considered benign. In the production environment, some of the operations may be benign while other operations may be malicious. In such a scenario, the computing device (102) processes the operations in a manner that balances the security of the overall system with useability constraints.

While FIG. 1 shows a direct connection between the user device and the computing system (102), the connection may be indirect. For example, the user device (180) may trigger operations from other computing systems (not shown) and from other applications that are then received by the computing device (102).

Generally, an operation is an instruction or set of instructions being executed by at least one computer processor as part of executing the instrumented application. An instance of an operation is a particular time in which the instruction or set of instructions are being executed. Thus, multiple instances of the same operation may exist, whereby the multiple instances refer to the different times in which the operation is performed. The operations may be to manipulate a datastore, to transmit information, or to perform another protected action. For example, a user may utilize a user interface to cause the computer to manipulate data within a datastore. In performing the operation, the instrumented application (155) may read or write data to the datastore.

In addition to the instruction, the operation may also include the set of parameters used to execute the instruction. For example, the set of parameters may be the arguments received and used in processing the operation. The set of parameters may be a specification of the data to access or store in a database query. As another example, the set of parameters may specify a modification to the schema of the database. The set of parameters may be generated from the input received from the user or from another application.

In one or more embodiments, the application is an instrumented application (155). The instrumented application (155) includes instrument code. Instrumenting an application adds hooks to the application to perform monitoring and blocking operations. Further, the hooks in the application may also gather application context information. Instrumenting the application modifies the application executable. In one or more embodiments, the software agent may instrument the runtime code of the application, or the source code of the application may be instrumented to cause the runtime application to be instrumented as well.

The agent (158) is a software that may execute in the same process and runtime as the instrumented application (155). In one or more embodiments, the agent (158) has read and write access to the application code and data of the instrumented application (155). The agent (158) is configured to gather context of the instrumented application (155), push information to the security service (104), pull configurations and allowlists from the security service (104), and augmenting the application code of the instrumented application (155) with additional logic.

The software agent (158) is connected to a data repository (108) and a monitor (116). A data repository (108) is any type of storage unit and/or device (e.g., a file system, database, data structure, or any other storage mechanism) for storing data. Further, a data repository (108) may include multiple different, potentially heterogeneous, storage units and/or devices. The data repository (108) stores data for a software agent (158) and monitor (116). The data repository (108) stores a context-specific allowlist (e.g., allowlist X (120), allowlist Y (122)), corresponding context data (e.g., context data X (124), context data Y (126)), and corresponding confidence ratings (e.g., confidence rating X (128), confidence rating Y (130)), and configuration parameters (118).

The context-specific allowlist (e.g., allowlist X (120), allowlist Y (122)) is a list of allowed operations, including corresponding parameters. Operations not in the allowlist are blocked while operations specified in the allowlist are allowed. In one or more embodiments, the operations in the allowlist are generalized. The generalization may be of the instruction or of the parameters. By way of an example of a generalized instruction, “add column”, “add table”, and “delete column” in a database may be generalized to an instruction specifying to modify the database schema. Parameters may also be generalized. For example, some of the parameters of an operation may be missing in the allowlist even if required by the operation. A missing parameter indicates that any value of the parameter for the operation is allowed. As another example, a generalized format of a parameter indicates that any value of a parameter satisfying the generalized format is allowed. The generalization provides for operations to be allowed even though the operations have not previously been processed by the application.

Each context-specific allowlist (e.g., allowlist X (120), allowlist Y (122)) is defined for a corresponding context. The context data (e.g., context data X (124), context data Y (126)) specifies the context. The context is the circumstances in which the operation is being performed. In one or more embodiments, the context may be, or include the execution context of the operation. For example, the context may include one or more of the code location in which the operation exists, the stack trace, and the values of variables in the heap. Similar to operations, the context in the context data (e.g., context data X (124), context data Y (126)) may be generalized. The generalization provides for the same allowlist to be associated with multiple specific contexts. In other words, the contexts may be expressly or implicitly partitioned into groups, and each group of contexts may be associated with a unique corresponding allowlist. The corresponding allowlist to the group is different than the allowlists associated with other groups. For example, the code location may be a range of locations where some of the variable values may not be specified indicating that such variable values do not matter or may be ranges of values. Similarly, the stack trace may have portions undefined.

In one or more embodiments, each allowlist is also related to a corresponding confidence rating (e.g., confidence rating X (128), confidence rating Y (130)). The confidence rating is a value identifying the confidence of the system in the corresponding generated context-specific allowlist. The confidence rating (e.g., confidence rating X (128), confidence rating Y (130)) is a function of a number of observations having the corresponding context and the metrics in using the allowlist to process the observations. In some embodiments, the confidence rating is only defined during training when observations are prelabeled or are all benign and not defined when the allowlists are deployed to production.

The configuration parameters (118) include the current mode of the software agent (158) as well as other possible configurations of the software agent (158). In one or more embodiments, the software agent (158) may operate in one of many modes with respect to an allow list. Example modes include a logging mode, an alerting mode, and a blocking mode. During the logging mode when the system is in training, the software agent (158) gathers observations about the target application to enable the synthesis of the allowlist. In alerting mode in the production environment, the software agent (158) alerts about allowlist violations. In one or more embodiments, the software agent (158) in the alerting mode does not interfere with the target application (e.g., does not block performance of the operations by the target application). In some embodiments, such as when increased security is used, the software agent (158) blocks performance of the operations while in alerting mode. In blocking mode in a production environment, the software agent (158) interrupts and blocks any operation that violates the allowlists.

In one or more embodiments, the monitor (116) is configured to make decisions whether to block, or not block, an operation. In one or more embodiments, the determination to block, or not block, is a two-part determination. The first part of the determination is whether an operation is within the allow list. The second part of the determination is whether a confidence level satisfies a threshold. The monitor (116) is configured to block or allow operations based on the allow list.

Continuing with FIG. 1, the security service (104) orchestrates the execution of the infrastructure of the system. The security service (104) is responsible for collecting and storing observations sent by the software agent, creating context-specific allowlists from collected observations, and deploying the system when the confidence rating satisfies a corresponding threshold. The security service (104) may also interact with users through an interface.

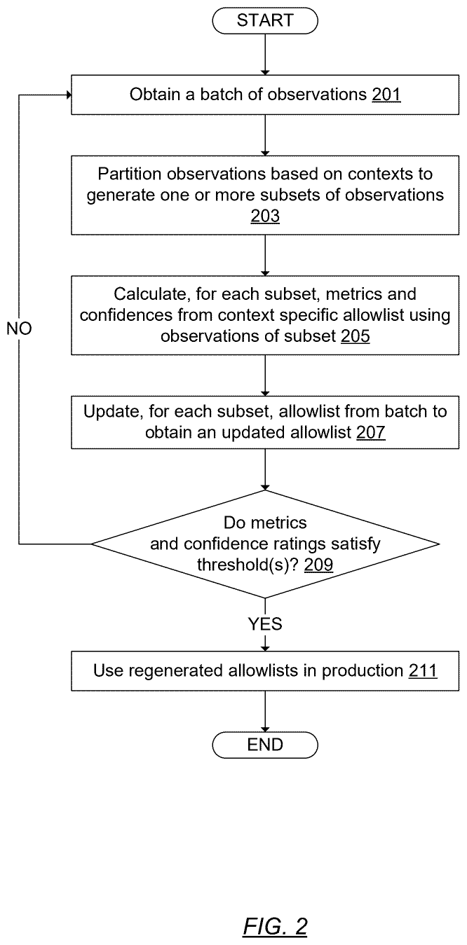

The security service (104) includes an allowlist generator (132). The allowlist generator (132) is configured to iteratively generate context-specific allowlists (e.g., allowlist X (120), allowlist Y (122)). The process of generating context-specific allowlists is described in reference to FIG. 2 below. The allowlist generator (132) may use metric thresholds (134) to determine whether to continue generating allowlists. A metric threshold is a threshold on a metric use to measure a number of observations that are allowed by an allowlist, and a number of observations that are blocked by an allowlist. The metric threshold(s) (134) may specify when to re-generate an allowlist based on the metrics.

The observation repository (136) is a data repository (as described above) that stores observations. An observation is the occurrence or instance of an operation by the instrumented application (155) along with accompanying metadata, security action, if determined, and a context. For example, the observations may be observations in the trusted environment.

While FIG. 1 shows a configuration of components, other configurations may be used without departing from the scope of the invention. For example, various components may be combined to create a single component. As another example, the functionality performed by a single component may be performed by two or more components.

FIG. 2 shows a diagram for generating context-specific allowlists in accordance with one or more embodiments. While the various steps in this flowchart are presented and described sequentially, at least some of the steps may be executed in different orders, may be combined or omitted, and at least some of the steps may be executed in parallel. Furthermore, the steps may be performed actively or passively.

In Block 201, a batch of observations is obtained. In one or more embodiments, the batch of observations includes multiple instances of operations. When the initial batch of observations are obtained, the target application is assumed to be in a trusted environment. Thus, the initial batch of observations are not blocked and may be benign. The security service obtains the agent identifier transmitted with the initial batch of observations and uses the agent identifier to store the observations in the agent specific compartment for the agent. In some embodiments, the observations may be displayed to the user to label the observations as benign or malicious. In some embodiments, because the application is in a trusted environment when the observations are obtained, the observations are assumed to be benign.

To obtain a batch of observations, the instrumented application is executed in a protected environment by several users. While using the application, either as testing or for end use, the users may request various operations to be performed. Some of the operations may be protected operations as defined by the instrumentation. When the protected operation is executed for a user, the instruction, parameters, and context are stored as an observation. For example, the operation and context data may be stored in a log. In one or more embodiments, in the trusted environment, the execution may proceed without waiting for a response. In other embodiments, the operation may proceed if allowed by an allowlist or a human. When the number of observations satisfy a threshold, the observations are grouped in a batch to generate an allowlist. The processing of Block 201 may be performed continually over the course of a variety of execution scenarios. The result is multiple successive batches of observations. The processing of FIG. 2 may be performed online while the batches are being obtained.

In Block 203, the observations in the batch are partitioned based on contexts to generate one or more subsets of observations. For each observation, the context of the observation is determined. The context of the observation is compared to a context associated with each allowlist to identify a matching context. The matching context is the context that is identical or is a generalized form of the context in the observation. In some embodiments, the contexts that correspond to each allowlist are pre-configured. In other embodiments, a clustering algorithm may be performed to cluster contexts associated with an operations associated with batches. For example, the number of allowlists may be defined. The number of allowlists are the number of clusters of contexts. The context data associated with multiple instances of multiple operations are clustered. For each cluster, a context data is defined that is a generalization of the contexts assigned to the cluster.

The processing of Block 203 may divide the batch into one or more subsets of observations, whereby the observations in the subset match the context data associated with an allowlist.

In Block 205, for each subset, metrics and confidences are calculated from context-specific allowlist using observations of the subset. For each subset identified in Block 203, the processing of Blocks 205 and 207 may be independently performed using just the observations in the subset. The operation is compared to the allowlist to determine whether the allowlist authorizes the operation. If the processing in Block 205 is in a trusted environment, then any unauthorized operation is a false positive (i.e., a false blocking). Namely, the operation is blocked by the allowlist by not being expressly authorized. Otherwise, the operation is allowed. By comparing the operation of each observation in the subset to the context-specific allowlist, a metric is determined. For example, the metric may be the number of false blockings as specified by the context-specific allowlist in the subset. As another example, the metric may be the percentage of false blockings. Other metrics may be calculated without departing from the scope of the claims. Further, a confidence rating is calculated independently for each context-specific allowlist. The confidence rating may be determined from the metric and the number of observations in subsets that span the batches of observations. Specifically, the confidence rating may be a function of the metric and a total number of observations having a context that matches the context data corresponding to the particular context-specific allowlist. The processing is performed for each affected allowlist. Namely, the processing is performed for each allowlist having a corresponding subset.

In Block 207, for each affected context, the allowlist is updated from batch to obtain an updated allowlist. In some embodiments, the corresponding context-specific allowlist is updated when the metric calculated from the subset fails to satisfy a metric threshold. In other embodiments, the allowlist is updated regardless of the metrics. The process of generating an allowlist is performed by generalizing a collection of concrete operations into a single formula against which future operations can be checked.

For the initial batch of observations, the context-specific allowlists may be empty. In one or more embodiments, the security service generalizes the operations in the subset of observations into general operations that are added to an allow list. Different heuristic-based rules may be applied to generalize the operations. For example, one heuristic is that if a parameter of a same operation in different observations labeled benign has various values within a range and no observations having a parameter value within the range is labeled malicious, then the value of the parameter may be generalized to the range. The more generalized the operations are, the more likely that a legitimate operation that has not been performed before will be allowed as well as the’ more likely that a nefarious operation will be allowed.

As more batches of observations are received, and more subsets corresponding to a particular context-specific allowlist is identified, the corresponding context-specific allowlist is iteratively updated. The iterative updating may be performed by adding to the current context-specific allowlist to create an updated allowlist or regenerating the context-specific allowlist. The decision may be determined based on the metric. For example, if the number or percentage of false positives is greater than a threshold, the context-specific allowlist may be regenerated. However, if the number or percentage of false positives is less than a threshold, then the false positives may be added to the allowlist to update the allowlist. If regenerating is performed, the regeneration is based on the current subset of observations as well as past subsets of observations.

In Block 209, a determination is made whether the metrics and confidence ratings satisfy a threshold. Batches of observations may have an inequitable distribution to the context-specific allowlists. Thus, some context-specific allowlists may have more observations in the subset then other context-specific allowlists. Multiple confidence thresholds may be defined. The different confidence thresholds may be defined for different levels of observations or for different allowlists. For example, an operation in a particular context that is determined to have minimal security vulnerability may be associated with a lower confidence threshold than an operation that has a greater security vulnerability. Thus, the context-specific allowlists may have different confidence thresholds to achieve before being deemed to be acceptable for deployment. If the metric fails to satisfy a metric threshold, the allowlist may be updated and more observations may be acquired. If the confidence rating for the metric fails to satisfy the threshold, then more observations may be acquired. The confidence threshold may be calculated based on percentages of pass rates. For example, the confidence threshold may be predefined or calculated from confidence ratings associated with multiple applications.

The determination whether to continue may be performed independently for each context-specific allowlist or across all context-specific allowlists, including the context-specific allowlist that does not have a current subset of observations. If certain context-specific allowlists do not have any subset of observations over the span of a predefined number of batches, an alert may be generated to indicate that more observations should be acquired for the particular context.

If the metrics and confidence ratings do not satisfy a threshold, the flow returns to Block 201 to obtain the next batch of observations. As the batches are received, the batches may be processed to test and update the context-specific allowlists.

If the determination is made that the metrics and confidences satisfy a threshold, then in Block 211, the regenerated allowlists are used in production. In production, during executing an instrumented application in a deployment environment, a user operation is received. The application context of the user operation is determined as described above with reference to Block 201. From the context-specific allowlists, the context-specific allowlist corresponding to the application context is selected. The selection may be performed as described above with reference to Block 203. The user operation is blocked when not permitted by the context-specific allowlist. In some cases, responsive to the blocking, information about the blocking, such as the context data, the confidence rating corresponding to the context-specific allowlist is transmitted as part of a report or an alert. When the user views the report or alert, the user can provide feedback on observations in the form of labels and confidence levels. The feedback is then pushed to the feedback handler and stored in the observation database to help improve the next generation of allowlists and set the confidence threshold. Namely, the user interface obtains selections from the user in the form of assigned labels, which are then stored with the observations. The selections may be to add a label or to modify an existing label.

The following example implementation is for explanatory purposes only and not intended to limit the scope of the invention.

Context is data which represents a particular area of the application. The context could be broad, such as an entire package, or specific, such as a single function. Context-specific allowlists are a set of allowlists, each corresponding with a different context in an application. A specific context-specific allowlist is a single allowlist for a particular context/area within a program, such as a package or call site. Deployment is when an allowlist is deployed to begin alerting or blocking malicious behavior against an application. A false positive is when valid operation is rejected according to the context sensitive allowlist. Finalization is the point in time at which an allowlist is determined to be ready for deployment. The learning phase is the period when the allowlist learner is receiving observations and calculating the metrics related to finalization and confidences. Policy is a generic term for a security policy, and the context sensitive allowlist is a subset of the policy.

When a developer wants to use an allowlist-based RASP solution for their application, a challenge to adoption is obtaining a training set of observations that will produce an allowlist with sufficiently low false positives to produce meaningful alerts during production deployment. Reducing false positives is done by ensuring that enough application behavior has been observed to cover a wide range of data. If the coverage is not over a wide range, then the allowlist may under approximate, and does not allow all benign application behavior. An under approximated allowlist will throw false positives during regular application behavior, which can be a difficult challenge for users to identify which alerts should be ignored and which are actual malicious attacks.

Obtaining a sufficiently extensive training set for the allowlist may be done by logging all relevant application behavior which relates to the particular security sensitive operation. A priori execution of all the relevant behavior that an application may use during production deployment can be challenging. The methods of doing so can be generally split into the following two groups: high developer overhead methods (e.g., creating an extensive test suite or manually exercising application behavior) and low developer overhead methods (e.g., logging operations from a deployed application or running random testing, such as fuzzing). Regardless of the method used to generate logs of security sensitive operations, the method may have the same usability issues when generating an allowlist for use during deployment. Namely, there is no way of determining how complete the allowlist is before deployment. Further, the context-specific allowlists generally have contained additional information to help prioritize between false positives and real malicious detections. Both of these issues can contribute to “alert fatigue”—an issue in cybersecurity where overly sensitive security tools cause so many alerts, many of which are false positives, that the users responding to them no longer do so in a timely and effective manner, or even respond at all.

Solving the first issue helps with adoption, as having proper coverage could prevent allowlists from being deployed when under approximated, instead of training context-specific allowlists until the context-specific allowlists are ready and reducing the number of false positives seen.

The second issue is also the user experience of allowlist. Namely, from the user experience, a possibility of false positives exists due to lack of training examples provided. Providing additional information to users to help prioritize between alerts that are more likely to be malicious, and those that are likely false positives, can improve response time and reduce alert fatigue.

One or more embodiments may determine when an allowlist is ready for deployment based on expected future false positive rates and provide additional information to users in the form of context specific confidence levels for context-specific allowlists. By automatically finalizing a context-specific allowlist with confidences, the aforementioned issues of under-approximation may be handled. Thus, the user experience of adopting an allowlist-based RASP solution is improved. Both determining finalization and confidences are based off a system of periodic regeneration and testing of allowlists against a stream of incoming benign observations.

During the learning phase, any incoming data will be split into batches which can be based on duration, observation count, or other means to logically separate the data. Each batch will be tested against the current allowlist (starting as empty) and the number of observations which fail are recorded. From this data we can calculate a variety of metrics which represent the expected false positives of an allowlist. The metric may be a moving average (e.g., simple moving average, cumulative moving average, and exponential moving average), and an autoregressive integrated moving average (ARIMA).

A threshold may be set for finalization based off of the chosen metrics and an acceptable number of false positives, which depends on the context of use. When this threshold is met the learning phase finalizes, with the most recently generated allowlist becoming the final version and the data consumed being the training set.

Each of these metrics have advantages and requirements that make them more or less suitable depending on the applications being targeted and system performance limitations. Regardless of which metric or combination that is being used, the finalization threshold may be set empirically based on sample applications and/or use cases. Factors for the finalization threshold may include expected application complexity and behavior (volume and timing of observations), type of security-sensitive behavior(s) being monitored, system performance limitations (memory, compute, etc.), and the rate of false positives that is acceptable to report to users.

The learning phase may proceed as follows: Observations are received. Receiving observations may be from a currently running application or streamed in from where they are stored. The observations may be assumed to be benign.

Observations are batched based on criteria, generally, a set duration. Other criteria such as volume could be used if they suit the application and performance requirements better (smaller batches are expected to have worse performance).

The batch of observations is tested against the current allowlist, recording which observations pass (i.e., true positive) or fail (i.e., false positive). The false positive data from the observation batch is used to calculate the required metrics for finalization and confidences. Further, the context-specific allowlist is regenerated based on any failing observations. This allowlist regeneration includes confidences as discussed below.

The calculated expected false positives metric is compared against the empirically set threshold. If the false positive metric passes, then the process goes to the next step. Otherwise, if the false positive metric fails, the process goes back to receiving observations and waits for another batch.

The next step is to deploy the allowlist to begin blocking and alerting malicious behavior from the application.

Determining confidences for each context-specific allowlist is another function of the learning phase aimed at improving the user experience when the users are handling alerts during protection. When working with context data, certain contexts may see the vast majority of observations, while some contexts are seen uncommonly. An example is the security behavior of SQL queries. Applications which use SQL queries are interacting with a database. Generally, the behaviors can be categorized as SQL queries from common contexts, and SQL queries from infrequent/one-off contexts. SQL queries from common contexts include internal behavior (e.g., health checks to the database, and retrieving a user/session identifier) and frequent user behavior (e.g., logging in, and retrieving basic user information). SQL queries from infrequent/one-off contexts include one-off internal behavior (e.g., creating tables/database migrations upon application launch, and creating database functions), infrequent internal behavior (e.g., database migrations, and clearing caches), and infrequent user behavior (e.g., resetting passwords, and deleting accounts).

The SQL queries from infrequent/one-off contexts operations are a particular priority for the learning phase, as such infrequent queries are where most false positives will occur due to a lack of training data. Acquiring more examples of such infrequent queries during the learning phase would be ideal for generating more complete allowlists. However, because such queries occur infrequently, possibly taking days, weeks, or even longer, simply extending the learning phase to cover the infrequent queries may be impractical in many cases.

To help users handle the infrequent queries, one or more embodiments give each context-specific allowlist a confidence rating, with the aim of giving contexts with infrequent/one-off behaviors lower confidences so the end users know that any alerts from them have a higher likelihood of being false positives, and thus are lower priority. Contexts have more low confidence behaviors identified by analyzing the volume and amount/timing of false positives that they see during the learning phase. In general, the confidence analysis may the following form: A low confidence level has a low volume of observations and/or a high rate of false positives (FP). A medium confidence level has a medium volume of observations with a low expected FP or a high volume with medium expected FP. A high confidence level has a high volume of observations and a low number of, or no expected, false positives.

The thresholds for the volume of observations and expected false positives for each confidence level can be set to either constant values empirically determined from testing against sample applications, or dynamically calculated during the learning phase from other available metrics (e.g., the high confidence volume threshold could be derived from some percentage of the contexts with the highest volumes).

In some cases, each context-specific allowlist may be regenerated for each batch. However, in some cases full regeneration may not be needed. If the current batch contains no observations which relate to this particular context, then neither the context-specific allowlist or the confidence will be affected.

If there were observations which failed against the current context-allowlist, then the allowlist must be regenerated to include these unseen values. This will also require checking if the confidence is going to change based on the metrics calculated from this batch.

If the context-specific allowlist only has passing observations in the batch and is high confidence, then the confidence can only increase from seeing passing observations and is already at the maximum. Otherwise, if the context-specific allowlist is below high confidence, then the possibility exists that this batch of passing observations will lead to an increase in confidence. The context-specific allowlist is based on the metrics.

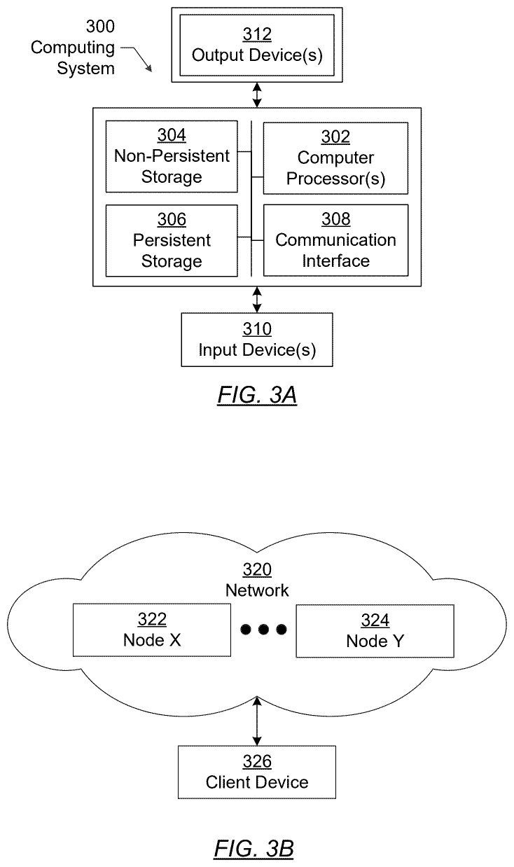

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 3A, the computing system (300) may include one, or more, computer processor(s) (302), non-persistent storage (304), persistent storage (306), a communication interface (308) (e.g., Bluetooth interface, infrared interface, network interface, optical interface, etc.), and numerous other elements and functionalities that implement the features and elements of the disclosure. The computer processor(s) (302) may be an integrated circuit for processing instructions. The computer processor(s) (302) may be one or more cores or micro-cores of a processor. The computer processor(s) (302) includes one or more processors. The one or more processors may include a central processing unit (CPU), a graphics processing unit (GPU), a tensor processing units (TPU), combinations thereof, etc.

The input device(s) (310) may include a touchscreen, keyboard, mouse, microphone, touchpad, electronic pen, or any other type of input device. The input device(s) (310) may receive inputs from a user that are responsive to data and messages presented by the output devices (312). The inputs may include text input, audio input, video input, etc., which may be processed and transmitted by the computing system (300) in accordance with the disclosure. The communication interface (308) may include an integrated circuit for connecting the computing system (300) to a network (not shown) (e.g., a local area network (LAN), a wide area network (WAN) such as the Internet, mobile network, or any other type of network) and/or to another device, such as another computing device.

Further, the output device(s) (312) may include a display device, a printer, external storage, or any other output device. One, or more, of the output device(s) (312) may be the same or different from the input device(s) (310). The input (310) and output device(s) (312) may be locally or remotely connected to the computer processor(s) (302). Many different types of computing systems exist, and the aforementioned input (310) and output device(s) (312) may take other forms. The output device(s) (312) may display data and messages that are transmitted and received by the computing system (300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (300) in FIG. 3A may be connected to, or be a part of, a network. For example, as shown in FIG. 3B, the network (320) may include multiple nodes (e.g., node X (322) and node Y (324)). Each node may correspond to a computing system, such as the computing system (300) shown in FIG. 3A, or a group of nodes combined may correspond to the computing system (300) shown in FIG. 3A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (300) may be located at a remote location and connected to the other elements over a network.

The nodes (e.g., node X (322), node Y (324)) in the network (320) may be configured to provide services for a client device (326), including receiving requests and transmitting responses to the client device (326). For example, the nodes may be part of a cloud computing system. The client device (326) may be a computing system, such as the computing system (300) shown in FIG. 3A. Further, the client device (326) may include and/or perform all, or a portion of, one or more embodiments.

The computing system (300) of FIG. 3A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a first batch of observations of an operation in a context;
partitioning the first batch of observations by the context to obtain a plurality of subsets of observations;
for each subset of a plurality of subsets of observations to obtain a plurality of metrics and a plurality of confidence ratings:
selecting, according to the context, a context-specific allowlist from a plurality of context-specific allowlists,
comparing the operation in each observation in the subset to the context-specific allowlist to obtain a metric regarding the subset, the metric in the plurality of metrics,
calculating a confidence rating for the metric from the subset, and
updating the context-specific allowlist for the first batch of observations; and
deploying the plurality of context-specific allowlists when the plurality of metrics and the plurality of confidences satisfy a threshold.

2. The method of claim 1, further comprising:
executing an instrumented application in a plurality of execution scenarios to obtain the first batch of observations.

3. The method of claim 1, wherein the instrumented application is executed in a protected environment by a plurality of users.

4. The method of claim 1, further comprising:
obtaining, during executing an instrumented application in a variety of execution scenarios, a plurality of batches of observations in a plurality of execution scenarios, wherein the plurality of batches comprising the first batch.

5. The method of claim 4, wherein, as the plurality of batches are received, the plurality of batches is processed to test and update the plurality of context-specific allowlists.

6. The method of claim 1, further comprising:
receiving, during executing an instrumented application in a deployment environment, a user operation;
identifying an application context of the user operation;
selecting, from the plurality of context-specific allowlists, the context-specific allowlist corresponding to the application context; and
blocking the user operation when not permitted by the context-specific allowlist.

7. The method of claim 6, further comprising:
transmitting, responsive to the blocking, the confidence rating corresponding to the context-specific allowlist to block the user operation.

8. The method of claim 1, wherein the context comprises a code location of the operation and a stack trace to the operation.

9. The method of claim 1, wherein the metric comprises a number of false blockings as specified by the context-specific allowlist in the subset.

10. The method of claim 1, further comprising:
generating the confidence rating by comparing the metric to a metric threshold and a number of observations associated with the context to a number threshold.

11. The method of claim 1, wherein the plurality of the confidence ratings is in a set of possible confidence ratings associated with a corresponding threshold.

12. The method of claim 11, wherein the corresponding threshold is dynamically calculated based on percentages of pass rates.

13. A system comprising:
a data repository comprising a plurality of context-specific allowlists;
a computer processor comprising computer readable program code for causing a computer system to perform operations comprising:
obtaining a first batch of observations of an operation in a context,
partitioning the first batch of observations by the context to obtain a plurality of subsets of observations,
for each subset of a plurality of subsets of observations to obtain a plurality of metrics and a plurality of confidence ratings:
selecting, according to the context, a context-specific allowlist from the plurality of context-specific allowlists,
comparing the operation in each observation in the subset to the context-specific allowlist to obtain a metric regarding the subset, the metric in the plurality of metrics,
calculating a confidence rating for the metric from the subset, and
updating the context-specific allowlist for the first batch of observations, and
deploying the plurality of context-specific allowlists when the plurality of metrics and the plurality of confidences satisfy a threshold.

14. The system of claim 13, wherein the observations further comprise:
executing an instrumented application in a plurality of execution scenarios to obtain the first batch of observations.

15. The system of claim 13, wherein the instrumented application is executed in a protected environment by a plurality of users.

16. The system of claim 13, wherein the observations further comprise:
obtaining, during executing an instrumented application in a variety of execution scenarios, a plurality of batches of observations in a plurality of execution scenarios, wherein the plurality of batches comprising the first batch.

17. The system of claim 16, wherein, as the plurality of batches are received, the plurality of batches is processed to test and update the plurality of context-specific allowlists.

18. The system of claim 13, wherein the observations further comprise:
receiving, during executing an instrumented application in a deployment environment, a user operation;
identifying an application context of the user operation;
selecting, from the plurality of context-specific allowlists, the context-specific allowlist corresponding to the application context; and
blocking the user operation when not permitted by the context-specific allowlist.

19. A non-transitory computer readable medium comprising computer readable program code for causing a computer system to perform operations comprising:
obtaining a first batch of observations of an operation in a context;
partitioning the first batch of observations by the context to obtain a plurality of subsets of observations;
for each subset of a plurality of subsets of observations to obtain a plurality of metrics and a plurality of confidence ratings:
selecting, according to the context, a context-specific allowlist from a plurality of context-specific allowlists,
comparing the operation in each observation in the subset to the context-specific allowlist to obtain a metric regarding the subset, the metric in the plurality of metrics,
calculating a confidence rating for the metric from the subset, and
updating the context-specific allowlist for the first batch of observations; and
deploying the plurality of context-specific allowlists when the plurality of metrics and the plurality of confidences satisfy a threshold.

20. The non-transitory computer readable medium of claim 19, wherein the plurality of operations further comprises:
executing an instrumented application in a plurality of execution scenarios to obtain the first batch of observations.
